(19) United States
(12) Patent Application Publication
(10) Pub. No.: US 2018/0070353 A1
(43) Pub. Date: Mar. 8, 2018

(54) SINGLE TIME SLOT SWITCHING BETWEEN QUASI-OMNI CCA AND DIRECTIONAL CCA TO SUPPORT SPATIAL REUSE IN WIRELESS COMMUNICATION NETWORKS

(71) Applicant: Intel IP Corporation, Santa Clara, CA (US)

(72) Inventors: Ou Yang, Santa Clara, CA (US); Solomon Trainin, Haifa (IL); Carlos Cordeiro, Portland, OR (US)

(73) Assignee: Intel IP Corporation, Santa Clara, CA (US)

(21) Appl. No.: 15/473,047

(22) Filed: Mar. 29, 2017

Related U.S. Application Data
(60) Provisional application No. 62/383,175, filed on Sep. 2, 2016.
(60) Provisional application No. 62/385,680, filed on Sep. 9, 2016.

(51) Int. Cl. H04W 72/04; H04W 74/08

(52) U.S. Cl. CPC H04W 72/0446; H04W 74/0808; H04W 72/046

(57) ABSTRACT

This disclosure describes systems, methods, and devices related to spatial reuse using quasi-omni and directional clear channel assessment (CCA). A device may use multiple antenna elements in an antenna array to perform both a quasi-omni CCA and a directional CCA during the same time slot. Some embodiments may use different antenna weight vectors to switch the antenna array between quasi-omni and directional CCA. Other embodiments may dedicate some elements of the array to quasi-omni CCA and other elements of the array to directional CCA. The device may use the combination of quasi-omni CCA and directional CCA to determine whether a channel is free for transmitting.

### CROSS REFERENCE TO RELATED APPLICATIONS

This application is derived from U.S. provisional application Ser. No. 62/383,175, filed Sep. 2, 2016, and is also derived from U.S. provisional application Ser. No. 62/385,680, filed Sep. 9, 2016. This application claims priority to those filing dates for all applicable subject matter, and incorporates those applications by reference.

### TECHNICAL FIELD

This disclosure generally relates to systems and methods for wireless communications and, more particularly, to spatial reuse using quasi-omni and directional clear channel assessment (CCA).

### BACKGROUND

Wireless devices are becoming widely prevalent and are increasingly requesting access to wireless channels. The growing density of wireless deployments require increased network and spectrum availability. Wireless devices may communicate with each other using directional transmission techniques, including but not limited to beamforming techniques. Directional antennas allow radiation patterns of wireless transmitters to be shaped to form directed beams. Beamforming represents techniques that can be used for enhancing throughput and range in wireless networks, including but not limited to next generation 60 GHz (NG60) network. Clear channel assessment (CCA) can take advantage of such beamforming, both for directional beamforming and for quasi-omni beamforming.

### BRIEF DESCRIPTION OF THE DRAWINGS

Some embodiments of the invention may be better understood by referring to the following description and accompanying drawings that are used to illustrate embodiments of the invention. In the drawings:

FIG. 1 depicts a network diagram illustrating an example network environment for spatial reuse using quasi-omni and directional clear channel assessment (CCA), in accordance with some demonstrative embodiments.

FIG. 2A depicts an illustrative schematic diagram for spatial reuse using quasi-omni and directional CCA, in accordance with one or more example embodiments of the present disclosure.

FIG. 2B depicts an illustrative schematic diagram for spatial reuse using quasi-omni and directional CCA, in accordance with one or more example embodiments of the present disclosure.

FIG. 2C depicts an illustrative table for spatial reuse using quasi-omni and directional CCA, in accordance with one or more example embodiments of the present disclosure.

FIG. 3 depicts a flow diagram of an illustrative process for spatial reuse using quasi-omni and directional CCA, in accordance with some demonstrative embodiments.

FIG. 4 illustrates a functional diagram of an example communication station that may be suitable for use as a user device, in accordance with some demonstrative embodiments.

FIG. 5 is a block diagram of an example machine upon which any of one or more techniques (e.g., methods) may be performed, in accordance with some demonstrative embodiments.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “wireless” may be used to describe circuits, devices, systems, methods, techniques, communications channels, etc., that communicate data by using modulated electromagnetic radiation through a non-solid medium. A wireless communications device may comprise at least one antenna, at least one radio, at least one memory, and at least one processor, where the radio(s) transmits signals through the antenna that represent data and receives signals through the antenna that represent data, while the processor(s) may process the data to be transmitted and the data that has been received. The processor(s) may also process other data which is neither transmitted nor received.

As used within this document, the term “access point” (AP) is intended to cover devices that schedule and control, at least partially, wireless communications by other devices in the network. An AP may also be known as a base station (BS), network controller (NC), central point (CP), PBSS Control Point (PCP) or any other term that may arise to describe the functionality of a network controller.

As used within this document, the term “STA” “mobile device” is intended to cover those devices whose wireless communications are at least partially scheduled and controlled by the network controller. A STA may also be known as a mobile device (MD), mobile station (MS), subscriber station (SS), user equipment (UE), or any other term that may arise to describe the functionality of a STA. Some STAs may move during communications, but movement is not required.

As used within this document, the term “communicate” is intended to include transmitting and/or receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed.

Example embodiments described herein provide certain devices, systems, methods, media, and means for spatial reuse using quasi-omni and directional CCA. The following description and the drawings sufficiently illustrate specific embodiments to enable those skilled in the art to practice them. Portions and features of some embodiments may be included in, or substituted for, those of other embodiments. Embodiments set forth in the claims encompass all available equivalents of those claims.

During communication between two devices, one or more frames may be sent and received. These frames may include one or more fields (or symbols) that may be based on various IEEE 802.11 specifications, including, but not limited to, an IEEE 802.11ad-2012 specification published 28 Dec. 2012, or IEEE 802.11ay specification published November 2015. Devices may operate in multiuser multiple-input and multiple-output (MU-MIMO) technology. It is understood that MIMO facilitates multiplying the capacity of a radio link using multiple transmit and receive antennas to exploit multipath propagation. MIMO provides a practical technique for sending and receiving more than one data signal on the same radio channel at the same time in different directions. MU-MIMO provides a way for wireless devices to communicate with each other using multiple antennas such that the wireless devices may transmit at the same time and frequency and still be separated by their spatial signatures. For example, using MU-MIMO technology, an AP may be able to communicate with multiple devices (e.g., STAs) at the same time using multiple antennas to send and receive data. An AP operating in MU-MIMO and in a 60 GHz frequency band may utilize an MU-MIMO frame to communicate with devices serviced by that AP.

Devices may communicate over a next generation 60 GHz (NG60) network, an enhanced directional multi-gigabit (EDMG) network, and/or any other network. Devices operating in EDMG may be referred to herein as EDMG devices. This may include user devices, and/or APs or other devices capable of communicating in accordance to a communication standard.

Spatial reuse for 60 GHz wireless communication is important, and there are various ways to improve spatial reuse. One of the reasons spatial reuse is important for 60 GHz wireless communication is that it increases capacity. In fact IEEE 802.11ay networks have large potential to enable more simultaneous links due to the directivity of the millimeter wave communication. It is understood that the millimeter waves are longer than infrared waves or x-rays, for example, but shorter than radio waves or microwaves. The millimeter-wave region of the electromagnetic spectrum corresponds to radio band frequencies of 30 GHz to 300 GHz and is sometimes called the Extremely High Frequency (EHF) range.

As used in this document, the term “antenna reciprocity” indicates a property of antennas in which the electrical characteristics of an antenna, such as gain, radiation pattern, impedance, bandwidth, resonant frequency, and polarization, are the same whether the antenna is transmitting or receiving.

Clear channel assessment (CCA) is typically defined as the technique of determining if a channel is clear (available for transmitting) by listening for a threshold level of energy at the relevant frequency. This is similar to receiving a communication, but without the expectation that the received energy can be decoded. If the received energy is above the threshold, it may be assumed that the channel is already being used, and transmitting by the listener might cause (or be subject to) interference. The listener should then wait until the energy drops below the threshold before reconsidering its attempt to transmit.

Directional CCA is typically defined as listening only over a narrow angle. Quasi-omni CCA is somewhat directional, but listens over a wider angle than directional CCA. Within the industry, ‘quasi-omni’ is sometimes referred to as ‘quasi-omni directional’ because it may deal with a significant portion of 360 degree antenna coverage, which is in turn frequently referred to as omni directional. But within this document, the term ‘quasi-omni’ will be used instead of ‘quasi-omni directional’ to avoid confusion with ‘directional’.

The distinction between quasi-omni and directional may be important because tuning the antenna for quasi-omni communication (including CCA) is typically faster and easier than tuning the antenna for directional CCA. In prior art systems, spatial reuse typically does not support quasi-omni CCA and directional CCA in the same time slot. Instead, quasi-omni CCA and directional CCA are typically performed in different time slots. Specifically, quasi-omni CCA may be performed first, and then directional CCA will be performed in a subsequent time slot if an EDMG STA is interested in spatial reuse. This approach has two problems. First, quasi-omni CCA is not maintained all the time, and hence the EDMG STA is not able to detect incoming data during the time the EDMG STA switched to directional CCA. Second, directional CCA is not performed all the time, and in fact may be performed only when request-to-send (RTS) and/or clear-to-send (CTS) with training is received. Therefore the CCA observation on a directional receive pattern may be very limited and a clear CCA may not guarantee a clear channel.

However, under that scenario the feasibility of spatial reuse at one EDMG STA may depend on other STAs' willingness to append training sequences to their RTS and/or CTS frames. An EDMG STA, in fact, may not be capable of enabling spatial reuse opportunity for other STAs. Appending training sequences to RTS and/or CTS frames introduces overhead for spatial reuse. An EDMG STA may also want to append a control trailer behind RTS and/or CTS frames in some cases. In that case, a solution would have to be implemented for the co-existence of TRN-R and control trailer. To address these and other issues with prior art systems, example embodiments of the present disclosure relate to systems, methods, and devices for spatial reuse using quasi-omni and directional CCA.

In some demonstrative embodiments, one or more devices may be configured to communicate an MU-MIMO frame, for example, over a 60 GHz frequency band. The one or more devices may be configured to communicate in a mixed environment such that one or more legacy devices are able to communicate with one or more non-legacy devices. That is, devices following one or more IEEE 802.11 specifications may communicate with each other regardless of which IEEE 802.11 specification is followed. A directional multi-gigabyte (DMG) communications may involve one or more directional links to communicate at a rate of multiple gigabits per second, for example, at least 1 gigabit per second, 7 gigabits per second, or any other rate. An amendment to a DMG operation in a 60 GHz band, e.g., according to an IEEE 802.11ad standard, may be defined, for example, by an IEEE 802.11ay project.

In some demonstrative embodiments, one or more devices may be configured to communicate over a next generation 60 GHz (NG60) network, an extended DMG (EDMG) network, and/or any other network. For example, the one or more devices may be configured to communicate over the NG60 or EDMG networks.

In one embodiment, a spatial reuse using quasi-omni and directional CCA system may facilitate a mechanism to maintain quasi-omni CCA and directional CCA at the same time in each time slot, and hence an EDMG STA may detect incoming data as well as sense the channel for outgoing data.

In one embodiment, a spatial reuse using quasi-omni and directional CCA system may facilitate, within a time slot, performing CCA on an EDMG STA by switching antenna patterns between quasi-omni RX and directional RX. Quasi-omni CCA may be used to receive any incoming packets, and directional CCA may be used to check whether the channel on the direction of transmission is clear. If an NAV entry is created by a frame that causes quasi-omni CCA busy but at the same time directional CCA is clear, the NAV entry may record the directional beam as an exclusion, meaning it is not required to honor the NAV entry when using the directional beam to access the channel. When quasi-omni CCA is busy, try to decode the packet and update NAV. Meanwhile set NAV exclusion according to the directional CCA result. If directional CCA is clear for PIFS and NAV is clear or the direction is excluded in all active NAVs, the EDMG STA may use the directional beam to access channel.

In one embodiment, the spatial reuse using quasi-omni and directional CCA system may facilitate within a time slot, an EDMG STA to perform CCA by switching antenna patterns between quasi-omni RX and directional RX. When both quasi-omni CCA and directional CCA are clear, physical carrier sensing is considered clear, otherwise the physical carrier sensing is considered busy and the EDMG STA should suspend its backoff timer.

In one embodiment, the spatial reuse using quasi-omni and directional CCA system may facilitate, when the backoff timer reaches zero, the EDMG STA to access the channel only when the directional CCA is clear for the most recent PIFS time.

The above descriptions are for purposes of illustration and are not meant to be limiting. Numerous other examples, configurations, processes, etc., may exist, some of which are described in greater detail below. Example embodiments will now be described with reference to the accompanying figures.

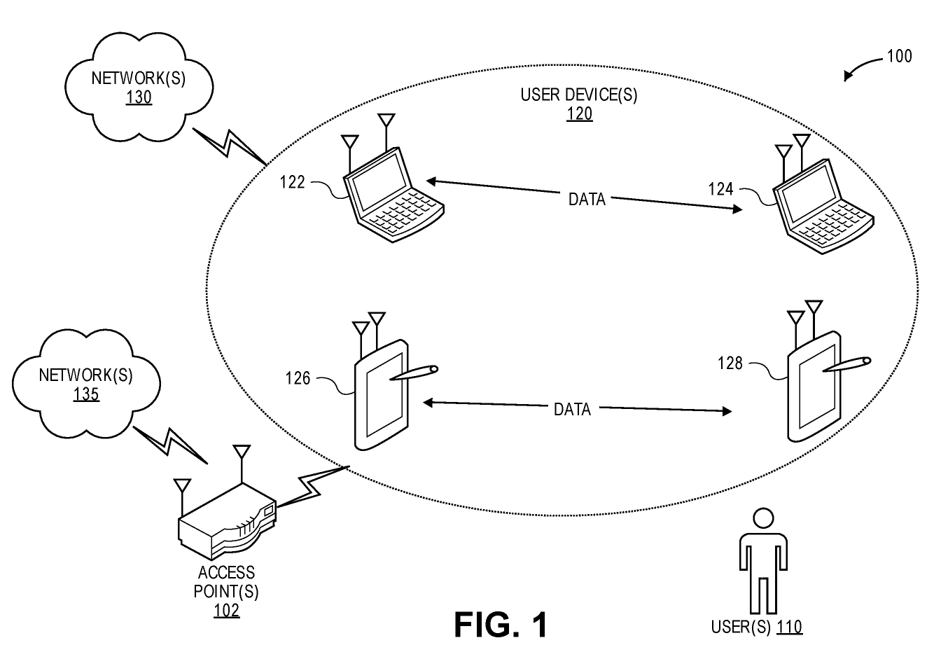

FIG. 1 is a network diagram illustrating an example network environment for spatial reuse using quasi-omni and directional CCA, according to some example embodiments of the disclosure. Wireless network 100 may include one or more user device(s) 120 (e.g., 122, 124, 126, 128) and one or more access point(s) (AP) 102, which may communicate in accordance with IEEE 802.11 communication standards, such as the IEEE 802.11ad and/or IEEE 802.11ay specifications. The one or more user device(s) 120 and the AP(s) 102 may be DMG or EDMG devices. The user device(s) 120 may be referred to as stations (STAs). The user device(s) 120 may be mobile devices that are non-stationary and do not have fixed locations.

One or more illustrative user device(s) 120 and/or AP 102 may be operable by one or more user(s) 110. In some embodiments, the one or more illustrative user device(s) 120 and/or AP 102 may operate as a personal basic service set (PBSS) control point/access point (PCP/AP). The user device(s) 120 and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. It is understood that the above is a list of devices. However, other devices, including smart devices, Internet of Things (IoT), such as lamps, climate control, car components, household components, appliances, etc. may also be included in this list.

Any of the user device(s) 120 (e.g., user devices 122, 124, 226, 228), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 122, 124, 226, 228), and AP 102 may include one or more communications antennas. The one or more communications antennas may be any suitable type of antennas corresponding to the communications protocols used by the user device(s) 120 (e.g., user devices 122, 124, 226 and 228), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The one or more communications antennas may be communicatively coupled to a radio component to transmit and/or receive signals, such as communications signals to and/or from the user devices 120 and/or AP 102.

Any of the user devices 120 (e.g., user devices 122, 124, 226, 228) and AP 102 may include multiple antennas that may include one or more directional antennas. The one or more directional antennas may be steered to a plurality of beam directions. For example, at least one antenna of a user device 120 (or an AP 102) may be steered to a plurality of beam directions. For example, a user device 120 (or an AP 102) may transmit a directional transmission to another user device 120 (or another AP 102).

Any of the user device(s) 120 (e.g., user devices 122, 124, 226, 228), and AP 102 may be configured to perform directional transmission and/or directional reception in conjunction with wirelessly communicating in a wireless network. Any of the user device(s) 120 (e.g., user devices 122, 124, 226, 228), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 122, 124, 226, 228), and AP 102 may be configured to perform any given directional transmission towards one or more defined transmit sectors. Any of the user device(s) 120 (e.g., user devices 122, 124, 226, 228), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 122, 124, 226, 228), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Some demonstrative embodiments may be used in conjunction with a wireless communication network communicating over a frequency band of 60 GHz. However, other embodiments may be implemented utilizing any other suitable wireless communication frequency bands, for example, an extremely high frequency (EHF) band (the millimeter wave (mmWave) frequency band), a frequency band within the frequency band of between 20 GHz and 300 GHz, a WLAN frequency band, a WPAN frequency band, a frequency band according to the WGA specification, and the like.

The phrases “directional multi-gigabit (DMG)” and “directional band (DBand)”, as used herein, may relate to a frequency band wherein the channel starting frequency is above 45 GHz. In one example, DMG communications may involve one or more directional links to communicate at a rate of multiple gigabits per second, for example, at least 1 gigabit per second, 7 gigabits per second, or any other rate.

In some demonstrative embodiments, the user device(s) 120 and/or the AP 102 may be configured to operate in accordance with one or more specifications, including one or more IEEE 802.11 specifications, (e.g., an IEEE 802.11ad specification, an IEEE 802.11ay specification, and/or any other specification and/or protocol). For example, an amendment to a DMG operation in the 60 GHz band, according to an IEEE 802.11ad standard, may be defined, for example, by an IEEE 802.11ay project.

Some communications over a wireless communication band (e.g., a DMG band) may be performed over a single channel bandwidth (BW). For example, the IEEE 802.11ad specification defines a 60 GHz system with a single channel bandwidth (BW) of 2.16 GHz, which is to be used by all stations (STAs) for both transmission and reception.

In some demonstrative embodiments, devices 102 and/or 140 may be configured to implement one or more mechanisms to extend a single-channel BW scheme (e.g., according to the IEEE 802.11ad specification) for higher data rates and/or increased capabilities.

Some specifications (e.g., an IEEE 802.11ad specification) may be configured to support a single user (SU) system, in which an AP cannot transmit frames to more than a single STA at a time. Such specifications may not be able to support an AP transmitting to multiple STAs simultaneously, using a multi-user MIMO (MU-MIMO) scheme (e.g., a downlink (DL) MU-MIMO), or any other MU scheme.

In some demonstrative embodiments, the user device(s) 120 and/or the AP 102 may be configured to implement one or more multi-user (MU) mechanisms. For example, the user device(s) 120 and/or the AP 102 may be configured to implement one or more MU mechanisms, which may be configured to enable MU communication of downlink (DL) frames using a multiple-input-multiple-output (MIMO) scheme between a device (e.g., AP 102) and a plurality of user devices, including user device(s) 120 and/or one or more other devices.

In some demonstrative embodiments, the user devices 120 and/or AP 102 may be configured to communicate over a next generation 60 GHz (NG60) network, an extended DMG (EDMG) network, and/or any other network. For example, the user devices 120 and/or AP 102 may be configured to communicate MIMO transmissions (e.g., DL MU-MIMO) and/or use channel bonding for communicating over the NG60 and/or EDMG networks.

In some demonstrative embodiments, the user devices 120 and/or AP 102 may be configured to support one or more mechanisms and/or features (e.g., channel bonding, single user (SU) MIMO, and/or multi user (MU) MIMO) in accordance with an EDMG standard, an IEEE 802.11ay standard and/or any other standard and/or protocol.

When an AP (e.g., AP 102) establishes communication with one or more user device(s) 120 (e.g., user devices 122, 124, 226, and/or 228), the AP 102 may communicate in a downlink direction, and the user device(s) 120 may communicate with the AP 102 in an uplink direction by sending frames in either direction. The frames may include one or more headers. These headers may be used to allow a device (e.g., the user device(s) 120 and/or the AP 102) to detect a new incoming frame from another device.

In one embodiment, and with reference to FIG. 1, a device (e.g., the user device(s) 120 and/or the AP 102) may be configured to communicate in accordance with MU-MIMO with one or more other users (e.g., the user device(s) 120 and/or the AP 102), for example, over a 60 GHz frequency band.

Typically, spatial reuse requires using directional CCA to sense the channel in order to identify an antenna pattern that does not introduce interference to others and hence can be used for transmission/reception. However, directional CCA limits the angle from which an EDMG STA (e.g., user devices 122, 124, 226, 228) can receive data. In order to detect and/or receive data from neighboring STAs within a wider angle, quasi-omni CCA should be maintained.

In order to improve spatial reuse, RTS/DMG CTS frames with TRN-R training sequences may be implemented. The RTS/DMG CTS frames with TRN-R training sequences may be achieved by determining that an EDMG STA has reciprocal DMG antennas, that the EDMG STA uses RTS and DMG CTS frames to reserve a TXOP, that the EDMG STA sends the RTS and DMG CTS frames with TRN-R training sequences. When an unintended receiver receives the RTS or DMG CTS frames with TRN-R training sequence, it may train its RX sectors during the TRN-R sequences and determine or otherwise identify any sectors having directional CCA clear. Those sectors with directional CCA clear are considered not interfered by the ongoing transmissions. When antenna reciprocity is assumed, the EDMG STA may use one of those sectors to transmit data despite of the ongoing transmissions.

However, the feasibility of spatial reuse at one EDMG STA depends on other STAs' willingness to append TRN-R sequences to their RTS and DMG CTS frames. An EDMG STA, in fact, may not be capable of enabling spatial reuse opportunity for other STAs. Appending TRN-R sequences to RTS and DMG CTS frames introduces overhead for spatial reuse. An EDMG STA may also want to append control trailer behind RTS and DMG CTS frames in some cases. In that case, a solution would have to be implemented for the co-existence of TRN-R and control trailer.

In one embodiment, a spatial reuse using quasi-omni and directional CCA system may maintain both quasi-omni CCA and directional CCA per time slot using antenna switching for spatial reuse while eliminating the TRN-R sequences appended on the RTS and DMG CTS frames.

In one embodiment, based on the EDCA queue status, an EDMG STA may know the destination STA that the next outgoing packet is intended to. As a result, the EDMG STA may determine the best TX sector it should use to transmit to the destination STA. This best TX sector may indicate the directional antenna pattern that the EDMG STA will maintain CCA in the following time until the packet is transmitted successfully.

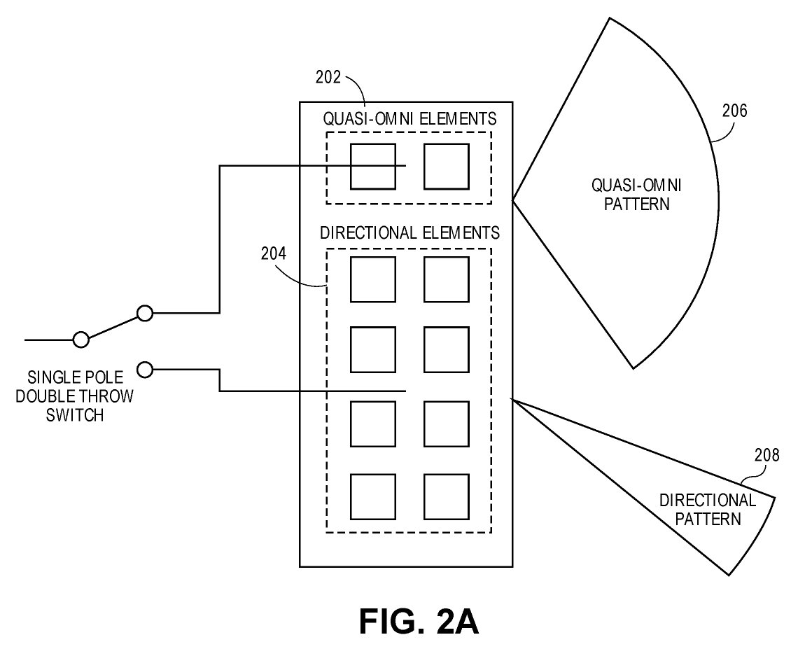

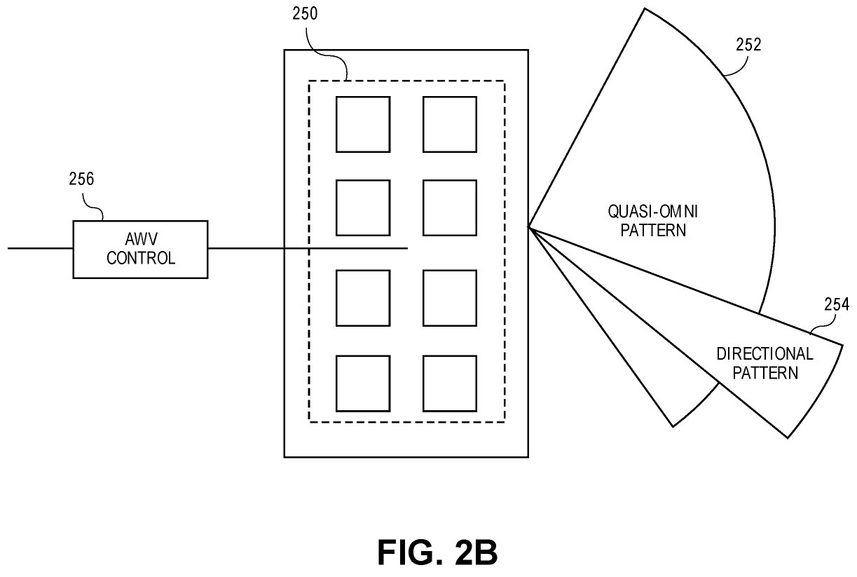

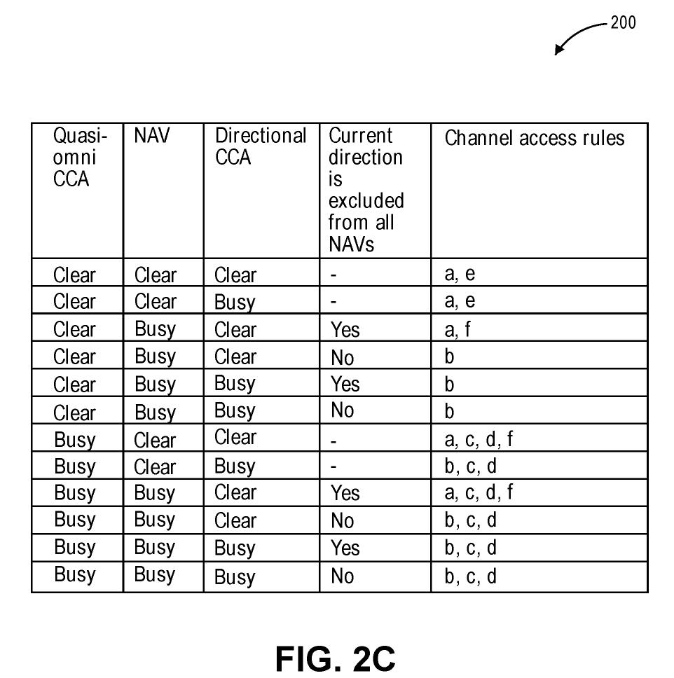

FIG. 2A depicts an illustrative schematic diagram for spatial reuse using quasi-omni and directional CCA, in accordance with one or more example embodiments of the present disclosure.

In one environment, one approach, as shown in FIG. 2A may be to separate antenna elements to achieve quasi-omni antenna pattern 206 and directional antenna pattern 208. In this case, one or more antenna elements (e.g., antenna elements 202) are dedicated to build the quasi-omni antenna pattern 206, and other antenna elements (e.g., antenna elements 204) may be dedicated to build the directional antenna pattern 208. In one embodiment, switching between quasi-omni and directional may require switching between the different sets of antenna elements. For example, using a single pole double throw switch in order to switch between quasi-omni and directional antenna pattern may be used. In another embodiment, because each CCA uses different antenna elements, with proper supporting circuitry it may be possible for the quasi-omni CCA and directional CCA to be performed at the same time.

In another embodiment, another approach as shown in FIG. 2B may be to use the same antenna elements 250 to generate a quasi-omni antenna pattern 252 and directional antenna pattern 254. In this case, switching between quasi-omni and directional requires separate antenna weight vectors (AWV) for each, so an AWV control 256 may be used to switch between the different AWVs. In either case, depending on the implementation, switching between quasi-omni and directional may take a very short time that may not affect the duration of one time slot.

FIG. 2C depicts an illustrative table 200 for spatial reuse using quasi-omni and directional CCA, in accordance with one or more example embodiments of the present disclosure.

In one embodiment, CCA and corresponding channel access rules may be as follows:

1) Each EDMG STA may maintain a quasi-omni CCA per time slot.

2) Each EDMG STA may maintain a directional CCA per time slot if there is at least one packet in the EDCA waiting to be transmitted. The directional CCA uses the best antenna pattern for the destination STA of the next outgoing packet.

3) When both quasi-omni and directional CCA are maintained, the EDMG STA switches between the quasi-omni CCA and the directional CCA in every time slot.

4) When only quasi-omni CCA is maintained in a time slot: 1) if quasi-omni CCA is busy or NAV is busy, suspend the backoff timer; 2) if quasi-omni CCA is clear and NAV is clear, decrease the backoff timer; and when backoff timer reaches 0, the EDMG STA may access the channel on any direction within its quasi-omni coverage.

5) When both quasi-omni CCA and directional CCA are maintained in a time slot, NAV is created/updated according to the following rules:
i) NAV is created/updated by a frame that is decoded using quasi-omni RX.
ii) If an EDMG STA maintains a NAV table with multiple NAVs: 1) when an NAV entry is created/updated by a frame that causes quasi-omni CCA busy but at the same time directional CCA is clear, the NAV entry also records the directional beam as exclusion of this NAV entry, meaning it is not required to respect the NAV entry when accessing channel using the directional beam; 2) and when an NAV entry is created/updated by a frame that causes quasi-omni CCA busy and at the same time directional CCA is busy, the NAV entry is created/updated with no exclusion, meaning no directional beam can be used when the NAV entry is not clear.
iii) If an EDMG STA maintains single NAV: 1) when an NAV entry is created by a frame that causes quasi-omni CCA busy but at the same time directional CCA is clear, the NAV entry also records the directional beam as exclusion of this NAV entry, meaning it is not required to respect the NAV entry when accessing channel using the directional beam; 2) when an NAV entry is created by a frame that causes quasi-omni CCA busy and at the same time directional CCA is busy, the NAV entry is created with no exclusion, meaning no directional beam can be used when the NAV entry is not clear; and 3) when an NAV entry is updated by a frame, no exclusion can be added to the NAV entry. An exclusion should be removed from the NAV entry if the corresponding directional beam is used in current directional CCA and the directional CCA is busy.

When both quasi-omni CCA and directional CCA are maintained in a time slot, these rules (a)-(f) may be observed, with reference to the last column in table 200 of FIG. 2C. That is:
(a) Decrease backoff timer.
(b) Freeze backoff timer.
(c) Try to decode packet using quasi-omni RX.
(d) Update NAV and NAV exclusion if needed.
(e) If backoff timer expires, allow to access channel.
(f) If backoff timer expires, check if directional CCA has been clear for PIFS. If yes, allow to access channel using the directional beam. If not, continue directional CCA until directional CCA is busy or directional CCA has been clear for PIFS time, whichever comes first. If directional CCA has been clear for PIFS, allow to access channel using the directional beam. If directional CCA becomes busy, generate a new backoff timer.

It is understood that the above descriptions are for purposes of illustration and are not meant to be limiting.

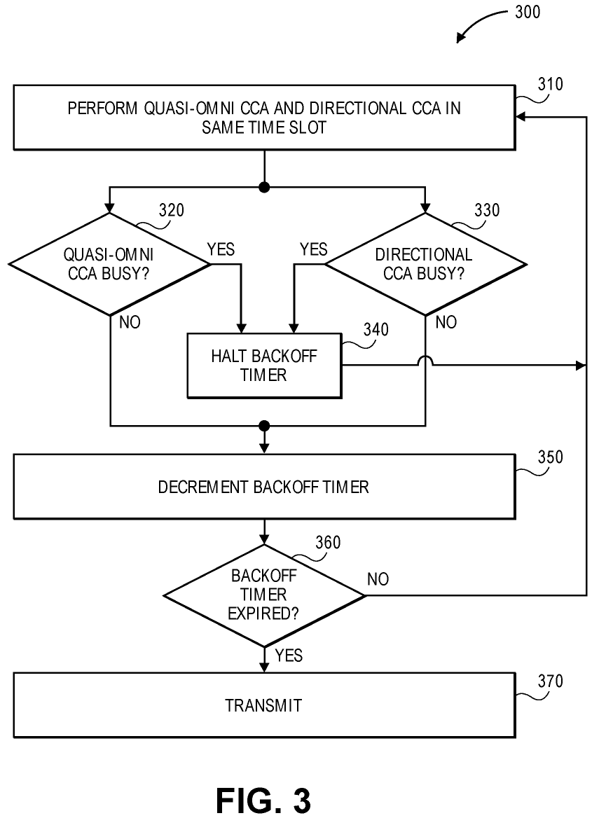

FIG. 3 illustrates a flow diagram of a method 300 for spatial reuse using quasi-omni and directional CCA system, in accordance with one or more example embodiments of the present disclosure.

At block 310, a device (e.g., the user device(s) 120 and/or the AP 102 of FIG. 1) may perform a quasi-omni CCA and a directional CCA in the same time slot. If either the quasi-omni CCA or directional CCA are busy (detect threshold level energy) as determined at block 320 or 330, the backoff timer may be halted at 340, where it can wait until the next time slot. If both the quasi-omni CCA and directional CCA are clear (do not detect threshold energy), as determined at 320 and 330, the backoff timer may be decremented at 350. When the backoff timer expires at 360, the device may transmit on a clear channel at 370. However, if the timer does not expire, the process 300 may be repeated in another time slot until the timer expires when both the quasi-omni and directional CCAs indicate not busy.

It is understood that the above descriptions are for purposes of illustration and are not meant to be limiting.

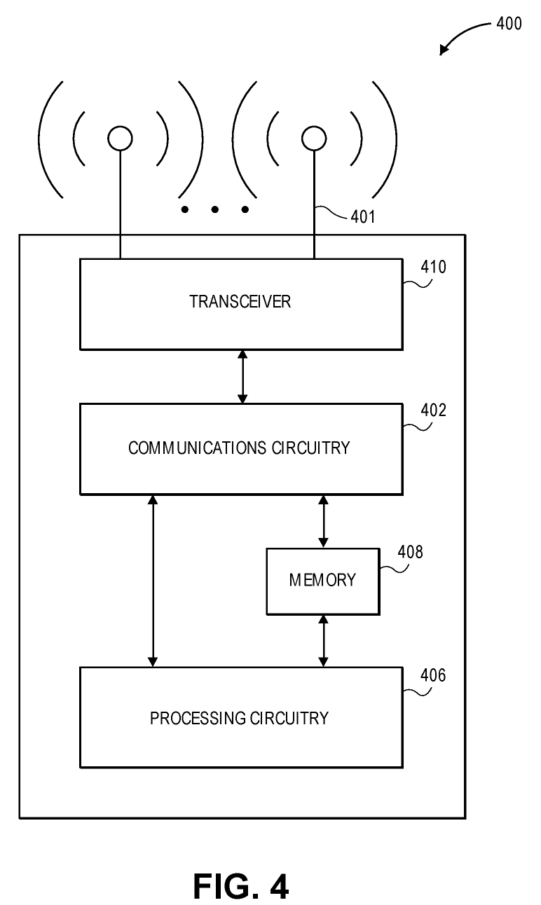

FIG. 4 shows a functional diagram of an exemplary communication station 400 in accordance with some embodiments. In one embodiment, FIG. 4 illustrates a functional block diagram of a communication station that may be suitable for use as an AP 102 (FIG. 1) or user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The communications circuitry 402 may include circuitry that can operate the physical layer (PHY) communications and/or media access control (MAC) communications for controlling access to the wireless medium, and/or any other communications layers for transmitting and receiving signals. The communication station 400 may also include processing circuitry 406 and memory 408 arranged to perform the operations described herein. In some embodiments, the communications circuitry 402 and the processing circuitry 406 may be configured to perform operations detailed elsewhere in this document.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device memory.

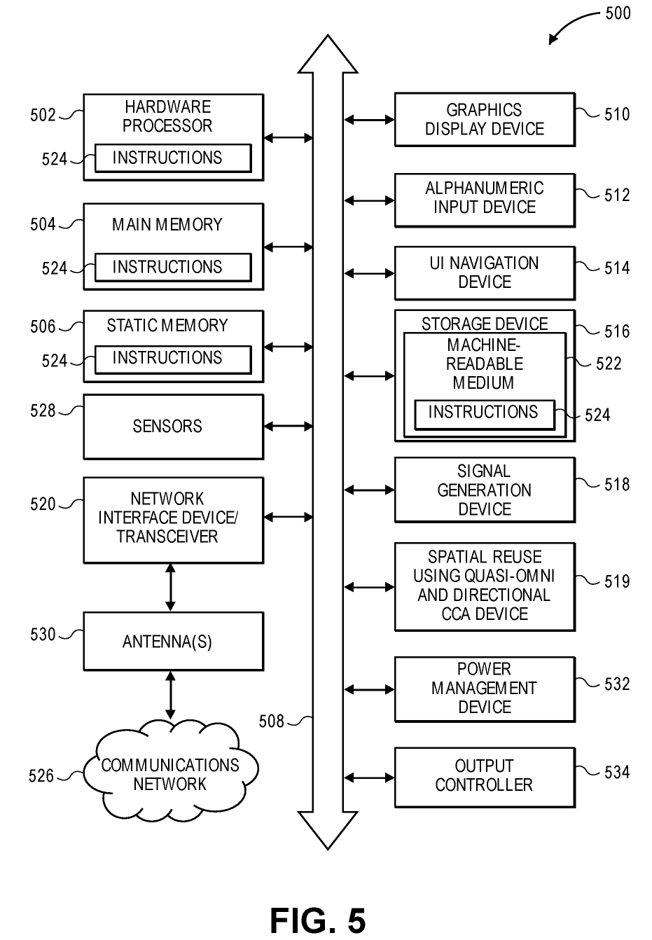

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), a spatial reuse using quasi-omni and directional CCA device 519, a network interface device/transceiver 620 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The spatial reuse using quasi-omni and directional CCA device 519 may carry out or perform any of the operations and processes (e.g., process 300) described and shown above. For example, the spatial reuse using quasi-omni and directional CCA device 519 may be configured to facilitate, within a time slot, performing CCA on an EDMG STA by switching antenna patterns between quasi-omni RX and directional RX. Quasi-omni CCA may be used to receive any incoming packets, and directional CCA may be used to check whether the channel on the direction of transmission is clear. If an NAV entry is created by a frame that causes quasi-omni CCA busy but at the same time directional CCA is clear, the NAV entry may record the directional beam as an exclusion, meaning it is not required to honor the NAV entry when using the directional beam to access the channel. When quasi-omni CCA is busy, try to decode the packet and update NAV. Meanwhile set NAV exclusion according to the directional CCA result. If directional CCA is clear for PIFS and NAV is clear or the direction is excluded in all active NAVs, the EDMG STA may use the directional beam to access channel.

The spatial reuse using quasi-omni and directional CCA device 519 may facilitate within a time slot, an EDMG STA to perform CCA by switching antenna patterns between quasi-omni RX and directional RX. When both quasi-omni CCA and directional CCA are clear, physical carrier sensing is considered clear, otherwise the physical carrier sensing is considered busy and the EDMG STA should suspend its backoff timer.

The spatial reuse using quasi-omni and directional CCA device 519 may facilitate, when the backoff timer reaches zero, the EDMG STA to access the channel only when the directional CCA is clear for the most recent PIFS time.

It is understood that the above are only a subset of what the spatial reuse using quasi-omni and directional CCA device 519 may be configured to perform and that other functions included throughout this disclosure may also be performed by the spatial reuse using quasi-omni and directional CCA device 519.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, singlecarrier CDMA, multi-carrier CDMA, multi-carrier modulation (MDM), discrete multi-tone (DMT), Bluetooth□, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

### Examples

The following examples pertain to particular embodiments:

Example 1 includes a first wireless communications device comprising at least one memory that stores computer-executable instructions, at least one processor configured to access the at least one memory, wherein the at least one processor is configured to execute the computer-executable instructions to perform a quasi-omni clear channel assessment (CCA) and a directional CCA during a same time slot, perform a communication with a second wireless communication device during the time slot resultant to determining that both the quasi-omni CCA and the directional CCA indicate a clear channel, and not perform the communication with the second wireless communication device during the time slot resultant to determining that either the quasi-omni CCA or the directional CCA indicate that the channel is not clear.

Example 2 includes the first device of example 1, wherein the first device includes an antenna array with multiple antenna elements, and the first device is to configure the multiple antenna elements in a first configuration for the quasi-omni CCA and to configure the multiple antenna elements in a second configuration for the directional CCA.

Example 3 includes the first device of example 2, wherein the first device is configured to perform the quasi-omni CCA and the directional CCA at different times in the same time slot.

Example 4 includes the first device of example 1, wherein the first device includes an antenna array with multiple antenna elements, the first device is to configure a first subset of the multiple antenna elements in a first configuration for the quasi-omni CCA, and the first device is to configure a second subset of the multiple antenna elements in a second configuration for the directional CCA.

Example 5 includes the first device of example 4, wherein the first device is configured to perform the quasi-omni CCA and the directional CCA at a same time in the same time slot.

Example 6 includes the first device of example 1, wherein the first device is to suspend a backoff timer resultant to determining that either the quasi-omni CCA or the directional CCA indicate physical carrier sensing is not clear.

Example 7 includes the first device of example 1, wherein the first device is to decrement a backoff timer resultant to determining that both the quasi-omni CCA and the directional CCA indicate physical carrier sensing is clear.

Example 8 includes the first device of example 1, wherein the first device includes a display.

Example 9 includes a method of wireless communication by a first wireless communication device, comprising performing a quasi-omni clear channel assessment (CCA) and a directional CCA during a same time slot, performing a communication with a second wireless communication device during the time slot resultant to determining that both the quasi-omni CCA and the directional CCA indicate a clear channel, and not performing the communication with the second wireless communication device during the time slot resultant to determining that neither the quasi-omni CCA nor the directional CCA indicate the channel is clear.

Example 10 includes the method of example 9, further comprising configuring multiple antenna elements in a first configuration for the quasi-omni CCA and configuring the multiple antenna elements in a second configuration for the directional CCA.

Example 11 includes the method of example 10, wherein said configuring the multiple antenna elements comprises configuring the multiple antenna elements in the first configuration and in the second configuration at different times in the same time slot.

Example 12 includes the method of example 9, further comprising configuring a first subset of multiple antenna elements in a first configuration for the quasi-omni CCA, and configuring a second subset of the multiple antenna elements in a second configuration for the directional CCA.

Example 13 includes the method of example 12, further comprising configuring the first subset and the second subset in the same time slot.

Example 14 includes the method of example 9, further comprising suspending a backoff timer resultant to determining that either the quasi-omni CCA or the directional CCA indicate physical carrier sensing is not clear.

Example 15 includes the method of example 9, further comprising decrementing a backoff timer resultant to determining that both the quasi-omni CCA and the directional CCA indicate physical carrier sensing is clear.

Example 16 includes a non-transitory computer-readable medium storing computer-executable instructions which when executed by one or more processors result in performing operations comprising: performing a quasi-omni clear channel assessment (CCA) and a directional CCA during a same time slot, performing a communication with a second wireless communication device during the time slot resultant to determining that both the quasi-omni CCA and the directional CCA indicate a clear channel, and not performing the communication with the second wireless communication device during the time slot resultant to determining that neither the quasi-omni CCA nor the directional CCA indicate the channel is clear.

Example 17 includes the medium of example 16, the operations further comprising configuring multiple antenna elements in a first configuration for the quasi-omni CCA and configuring the multiple antenna elements in a second configuration for the directional CCA.

Example 18 includes the medium of example 17, wherein said configuring the multiple antenna elements comprises configuring the multiple antenna elements in the first configuration and in the second configuration at different times in the same time slot.

Example 19 includes the medium of example 16, further comprising configuring a first subset of multiple antenna elements in a first configuration for the quasi-omni CCA, and configuring a second subset of the multiple antenna elements in a second configuration for the directional CCA.

Example 20 includes the medium of example 19, further comprising configuring the first subset and the second subset in the same time slot.

Example 21 includes the medium of example 16, further comprising suspending a backoff timer resultant to determining that either the quasi-omni CCA or the directional CCA indicate physical carrier sensing is not clear.

Example 22 includes the medium of example 16, further comprising decrementing a backoff timer resultant to determining that both the quasi-omni CCA and the directional CCA indicate physical carrier sensing is clear.

Example 23 includes a first wireless communications device comprising means to: perform a quasi-omni clear channel assessment (CCA) and a directional CCA during a same time slot, perform a communication with a second wireless communication device during the time slot resultant to a determination that both the quasi-omni CCA and the directional CCA indicate a clear channel, and not perform the communication with the second wireless communication device during the time slot resultant to a determination that either the quasi-omni CCA or the directional CCA indicate the channel is not clear.

Example 24 includes the first device of example 23, wherein the first device comprises means to configure multiple antenna elements in a first configuration for the quasi-omni CCA and to configure the multiple antenna elements in a second configuration for the directional CCA.

Example 25 includes the first device of example 24, wherein the first device comprises means to perform the quasi-omni CCA and the directional CCA at different times in the same time slot.

Example 26 includes the first device of example 23, wherein the first device comprises means to configure a first subset of the multiple antenna elements in a first configuration for the quasi-omni CCA, and configure a second subset of the multiple antenna elements in a second configuration for the directional CCA.

Example 27 includes the first device of example 26, wherein the first device comprises means to perform the quasi-omni CCA and the directional CCA at a same time in the same time slot.

Example 28 includes the first device of example 23, wherein the first device comprises means to suspend a backoff timer resultant to a determination that either the quasi-omni CCA or the directional CCA indicate physical carrier sensing is not clear.

Example 29 includes the first device of example 23, wherein the first device comprises means to decrement a backoff timer resultant to a determination that both the quasi-omni CCA and the directional CCA indicate physical carrier sensing is clear.

Example 30 includes the first device of example 23, wherein the first device comprises means for displaying.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A first wireless communications device comprising:
at least one memory that stores computer-executable instructions, at least one processor configured to access the at least one memory, wherein the at least one processor is configured to execute the computer-executable instructions to:
perform a quasi-omni clear channel assessment (CCA) and a directional CCA during a same time slot;
perform a communication with a second wireless communication device during the time slot resultant to determining that both the quasi-omni CCA and the directional CCA indicate a clear channel; and
not perform the communication with the second wireless communication device during the time slot resultant to determining that either the quasi-omni CCA or the directional CCA indicate that the channel is not clear.

2. The first device of claim 1, wherein:
the first device includes an antenna array with multiple antenna elements;
the first device is to configure the multiple antenna elements in a first configuration for the quasi-omni CCA and to configure the multiple antenna elements in a second configuration for the directional CCA.

3. The first device of claim 2, wherein the first device is configured to perform the quasi-omni CCA and the directional CCA at different times in the same time slot.

4. The first device of claim 1, wherein:
the first device includes an antenna array with multiple antenna elements;
the first device is to configure a first subset of the multiple antenna elements in a first configuration for the quasi-omni CCA; and
the first device is to configure a second subset of the multiple antenna elements in a second configuration for the directional CCA.

5. The first device of claim 4, wherein the first device is configured to perform the quasi-omni CCA and the directional CCA at a same time in the same time slot.

6. The first device of claim 1, wherein the first device is to suspend a backoff timer resultant to determining that either the quasi-omni CCA or the directional CCA indicate physical carrier sensing is not clear.

7. The first device of claim 1, wherein the first device is to decrement a backoff timer resultant to determining that both the quasi-omni CCA and the directional CCA indicate physical carrier sensing is clear.

8. The first device of claim 1, wherein the first device includes a display.

9. A method of wireless communication by a first wireless communication device, comprising:
performing a quasi-omni clear channel assessment (CCA) and a directional CCA during a same time slot;
performing a communication with a second wireless communication device during the time slot resultant to determining that both the quasi-omni CCA and the directional CCA indicate a clear channel; and
not performing the communication with the second wireless communication device during the time slot resultant to determining that neither the quasi-omni CCA nor the directional CCA indicate the channel is clear.

10. The method of claim 9, further comprising:
configuring multiple antenna elements in a first configuration for the quasi-omni CCA and configuring the multiple antenna elements in a second configuration for the directional CCA.

11. The method of claim 10, wherein said configuring the multiple antenna elements comprises configuring the multiple antenna elements in the first configuration and in the second configuration at different times in the same time slot.

12. The method of claim 9, further comprising:
configuring a first subset of multiple antenna elements in a first configuration for the quasi-omni CCA; and
configuring a second subset of the multiple antenna elements in a second configuration for the directional CCA.

13. The method of claim 12, further comprising configuring the first subset and the second subset in the same time slot.

14. The method of claim 9, further comprising suspending a backoff timer resultant to determining that either the quasi-omni CCA or the directional CCA indicate physical carrier sensing is not clear.

15. The method of claim 9, further comprising decrementing a backoff timer resultant to determining that both the quasi-omni CCA and the directional CCA indicate physical carrier sensing is clear.

16. A non-transitory computer-readable medium storing computer-executable instructions which when executed by one or more processors result in performing operations comprising:
performing a quasi-omni clear channel assessment (CCA) and a directional CCA during a same time slot;
performing a communication with a second wireless communication device during the time slot resultant to determining that both the quasi-omni CCA and the directional CCA indicate a clear channel; and
not performing the communication with the second wireless communication device during the time slot resultant to determining that neither the quasi-omni CCA nor the directional CCA indicate the channel is clear.

17. The medium of claim 16, the operations further comprising:
configuring multiple antenna elements in a first configuration for the quasi-omni CCA and configuring the multiple antenna elements in a second configuration for the directional CCA.

18. The medium of claim 17, wherein said configuring the multiple antenna elements comprises configuring the multiple antenna elements in the first configuration and in the second configuration at different times in the same time slot.

19. The medium of claim 16, further comprising:
configuring a first subset of multiple antenna elements in a first configuration for the quasi-omni CCA; and
configuring a second subset of the multiple antenna elements in a second configuration for the directional CCA.

20. The medium of claim 19, further comprising configuring the first subset and the second subset in the same time slot.

21. The medium of claim 16, further comprising suspending a backoff timer resultant to determining that either the quasi-omni CCA or the directional CCA indicate physical carrier sensing is not clear.

22. The medium of claim 16, further comprising decrementing a backoff timer resultant to determining that both the quasi-omni CCA and the directional CCA indicate physical carrier sensing is clear.
